(19) United States
(12) Patent Application Publication
(10) Pub. No.: US 2012/0050857 A1
(43) Pub. Date: Mar. 1, 2012

(54) STEREOSCOPIC 3D DISPLAY DEVICE

(76) Inventors: Jong-Hyuck Lee, Gumi (KR); Young-Sik Kim, Gumi (KR); Do-Heon Kim, Gumi (KR); Sang-Hun Park, Jung-Ri (KR)

(21) Appl. No.: 13/177,941

(22) Filed: Jul. 7, 2011

(30) Foreign Application Priority Data
Aug. 31, 2010 (KR) 10-2010-0085119

(51) Int. Cl. G02B 27/22

(52) U.S. Cl. 359/464

(57) ABSTRACT

A stereoscopic image display device allowing for viewing of a 3D image according to a glassless scheme is disclosed in which barrier pitches are desired to be suitable for a landscape display mode and a portrait display mode and the interocular distance is adjusted to compensate for a viewing distance to thus prevent a color breaking phenomenon occurring when a pivot function is implemented. The stereoscopic image display device includes: a display panel on which left and right eye pixels are alternately defined to display left and right images; and a first parallax barrier disposed between the display panel and a user and having a first barrier pitch for a landscape display mode and a second parallax barrier disposed between the display panel and the user and having a second barrier pitch for a portrait display mode, wherein the first and second barrier pitches are designed to be different to display a 3D image both in the landscape display mode and in the portrait display mode.

Pursuant to 35 U.S.C. §119(a), this application claims the benefit of earlier filing date and right of priority to Korean Application 10-2010-0085119, filed on Aug. 31, 2010, the content of which is incorporated by reference herein in its entirety.

### BACKGROUND

1. Field of the Invention

The present disclosure relates to a stereoscopic 3D display device and, more particularly, to a stereoscopic 3D display device having a pivot function capable of displaying a three-dimensional (3D) image both in a landscape display mode and in a portrait display mode.

2. Discussion of the Related Art

A 3D display simply refers to the whole of a system artificially reproducing a 3D image.

Here, the system includes a software-wise technology which makes an image shown three-dimensionally and hardware for implementing contents created by using the software-wise technology three-dimensionally. The reason for including the software area is because a stereoscopy implementation scheme of each 3D display hardware requires contents configured in a software manner.

Also, a virtual 3D display is a system allowing for a user to feel a three-dimensional effect by flat display hardware by using binocular disparity generated when the human's eyes are away from each other by about 65 mm in a horizontal direction, among various factors allowing the user to feel the three-dimensional effect. In other words, although human's eyes views the same object, they see slightly different images (that is, horizontal spatial information is slightly divided) due to the binocular disparity. When the two images are delivered to the brain through the retina, the brain precisely unites the two images to allow the user to feel a three-dimensional effect. Based on this, a 2D display device is designed to simultaneously display two left and right images and deliver them to the respective eyes to create a virtual three-dimensional effect, which is called a virtual 3D display.

In the virtual 3D display hardware device, in order to display images of two channels on a single screen, in most cases, a channel is output at a time, while changing the lines in one of horizontal or vertical directions on the single screen. When images of two channels are simultaneously output from the single display device, incase of a glassless scheme, the right image is delivered to the right eye as it is while the left image is delivered only to the left eye, in terms of the hardware structure. Also, in case of a glass method, the right image is covered to prevent the left eye from viewing it and the left image is covered to prevent the right eye from viewing it.

Although images of the two channels are output, while changing the lines, because the thickness of the lines and the space between the lines are very fine, namely, it is as fine as 0.1 to 0.5 mm, the human's eyes cannot recognize them but recognize the two images of the respective channels as if they were one image. In this respect, however, compared with the case of using 2D screen, the amount of information delivered to the eyes is divided into a half of each channel, disadvantageously halving the resolution and the perceived brightness.

A stereoscopic image display method includes a glass method in which a user wears glasses and a glassless method in which the user does not wear glasses.

The typical glassless method includes a lenticular scheme in which a lenticular lens plate on which cylindrical lenses are vertically arranged is installed in front of a display panel, and a parallax barrier scheme.

According to the parallax barrier scheme, two left and right images are alternately disposed at a certain interval behind an opening of a slit called a parallax barrier, and when the two images are viewed through the opening at a particular point in time, the both images can be separately viewed precisely. Namely, the parallax barrier scheme divides the two images by simply blocking left and right channels with a wall, rather than using an optical technique such as a polarization scheme, or the like.

FIG. 1 is a schematic view illustrating the configuration of a stereoscopic image display device based on a general parallax barrier scheme.

As illustrated, a stereoscopic image display device 10 according to the general parallax barrier scheme includes a display panel 30 for simultaneously displaying left and right images and a parallax barrier 20.

Left eye pixels (L) for displaying a left eye image and right eye pixels (R) for displaying a right eye image are alternately defined on the display panel 30, and the parallax barrier 20 is disposed between the display panel 30 and a user 40.

The parallax barrier 20 includes slits 22 and barriers 21 which are repeatedly arrange in a stripe form in a vertical direction to the user 40 to selectively allow light coming from the left and right pixels (L and R) to pass therethrough.

Accordingly, a left eye image displayed on the left eye pixel (L) of the display panel 30 reaches the user's left eye through the slit 22 of the parallax barrier 20, and a right eye image displayed on the right eye pixel (R) of the display panel 20 reaches the user's right eye through the slit 22 of the parallax barrier 20. In this case, the left and right eye images include separate images in consideration of the disparity which can be sensed by the user 40, and the user 40 combines the two images to recognize a 3D image.

Meanwhile, display devices are variously utilized in line with the Information Age recently advancing at a rapid pace. For example, a display device allowing one screen to be rotated vertically or horizontally so as to be used for respective purposes has been introduced, and it is currently utilized for a display screen of a mobile phone, a monitor, or the like.

Namely, the existing general display device is fixed to display only one of a landscape image having a horizontal width greater than a vertical height or the opposite portrait image, but recently, an image display device having a pivot function so as to be rotated to display a landscape image or a portrait image as necessary has been studied. Such an image display device is utilized to operate in a landscape display mode in case of watching movies, or the like, and operate in a portrait display mode, for example, in case of opening a plurality of text files to work on them to display various types of information.

However, the method of providing a landscape image and a portrait image according to the rotation of the display device is yet to fit 3D image displaying according to the parallax barrier or lens array scheme.

### BRIEF SUMMARY

A stereoscopic image display device includes: a display panel on which left and right eye pixels are alternately defined to display left and right images; and a first parallax barrier disposed between the display panel and a user and having a first barrier pitch for a landscape display mode and a second parallax barrier disposed between the display panel and the user and having a second barrier pitch for a portrait display mode, wherein the first and second barrier pitches are designed to be different to display a 3D image both in the landscape display mode and in the portrait display mode.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view illustrating the configuration of a stereoscopic image display device according to a general parallax barrier scheme;

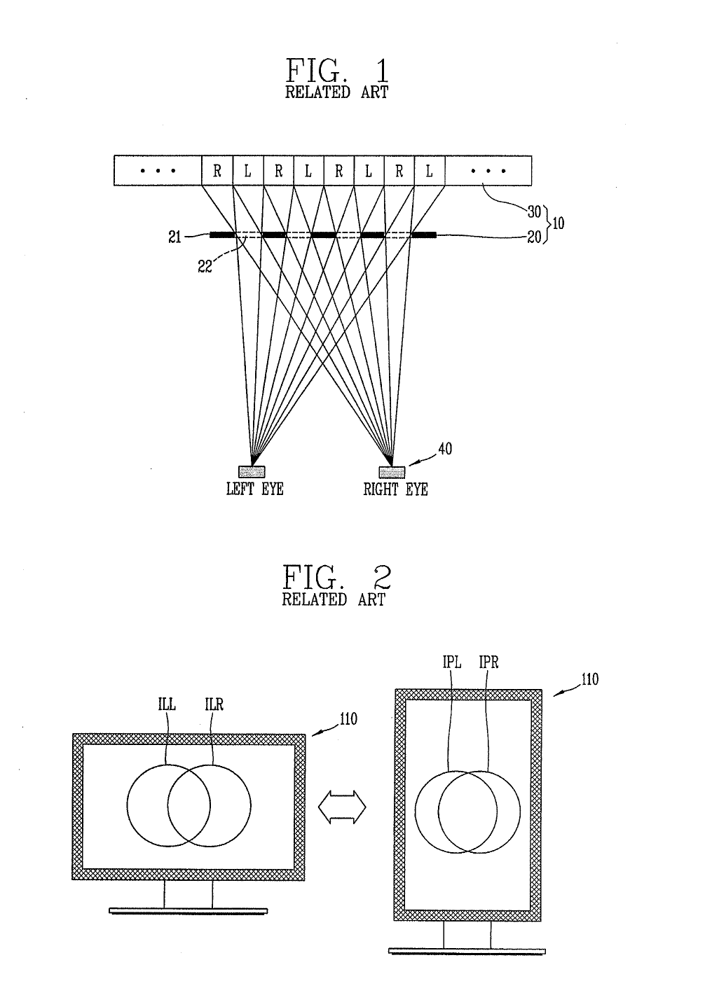

FIG. 2 is a view showing a state of displaying an image when the stereoscopic image display device according to a glassless scheme having a pivot function is rotated;

FIGS. 3 and 4 are schematic views showing pivot driving in the stereoscopic image display device according to a first exemplary embodiment of the present invention;

FIG. 5 is a view showing a state of displaying a 3D image in a landscape display mode in the stereoscopic image display device according to a second exemplary embodiment of the present invention;

FIG. 6 is a view showing a state of displaying a 3D image in a portrait display mode in the stereoscopic image display device according to the second exemplary embodiment of the present invention; and

FIG. 7 is a view showing an increase in a viewing distance according to a change in a barrier pitch in the stereoscopic image display device according to the second exemplary embodiment of the present invention.

### DETAILED DESCRIPTION OF THE DRAWINGS AND THE PRESENTLY PREFERRED EMBODIMENTS

A stereoscopic image display device according to exemplary embodiments of the present invention will now be described with reference to the accompanying drawings.

A glassless type 3D display has come to prominence. Among glassless type 3D displays, a method using a parallax barrier or a lens array has been most widely known, and the biggest issue of the glassless type 3D display is 3D crosstalk, a 3D luminance, or the like, and additionally, picture quality according to a viewing direction. Namely, whether or not 3D can be implemented without causing a problem in each direction by rotating a single screen vertically or horizontally is at issue.

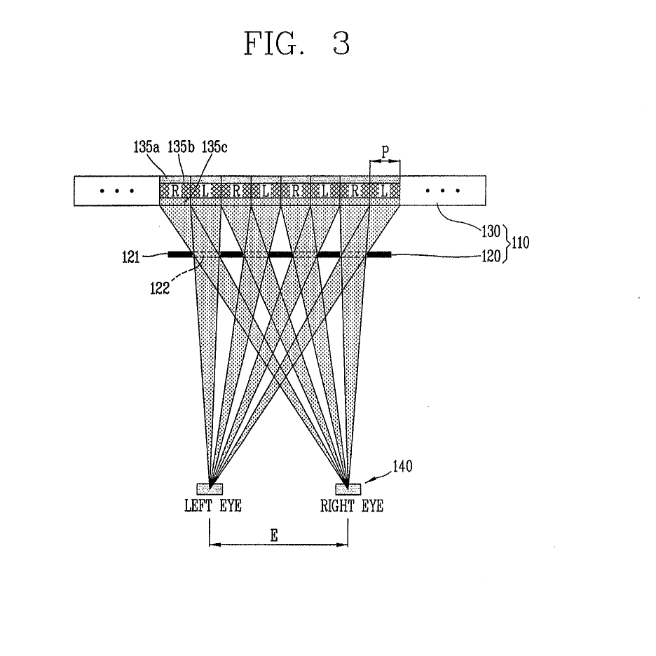

FIG. 2 is a view showing a state of displaying an image when the stereoscopic image display device according to a glassless scheme having a pivot function is rotated.

As illustrated, a stereoscopic image display device 110 according to an exemplary embodiment of the present invention has a pivot function operable in a landscape display mode and a portrait display mode.

First, when the stereoscopic image display device 110 operates in the landscape display mode in which a horizontally long image is displayed, the stereoscopic image display device 110 displays a landscape left eye image ILL and a landscape right eye image ILR which are separated left and right, and accordingly, the user combines the landscape left eye image ILL and the landscape right eye image ILR delivered to his left and right eyes, respectively, to recognize a three-dimensional landscape image.

When the stereoscopic image display device 110 is rotated at 90° to operate in a portrait display mode in which a vertically long image is displayed, the stereoscopic image display device 110 displays a portrait left eye image IPL and a portrait right eye image IPR which are separated left and right, and accordingly, the user combines the landscape left eye image IPL and the landscape right eye image IPR delivered to his left and right eyes, respectively, to recognize a three-dimensional portrait image.

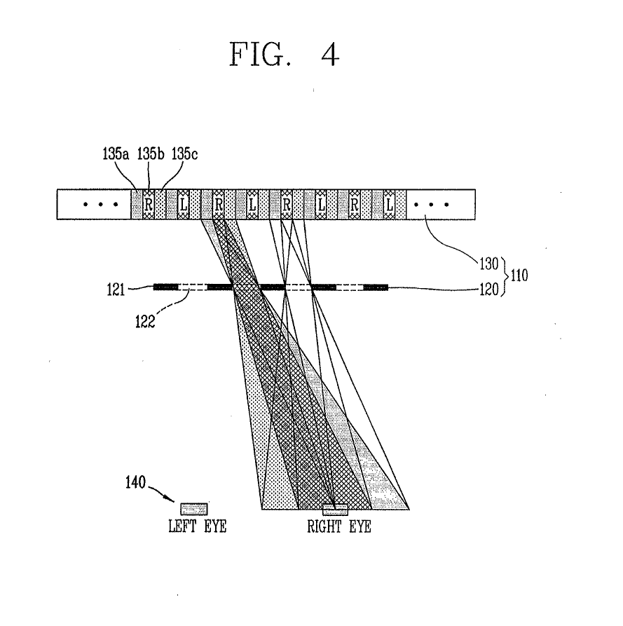

FIGS. 3 and 4 are schematic views showing pivot driving in the stereoscopic image display device according to a first exemplary embodiment of the present invention, specifically showing three-dimensional image display state in the landscape display mode and the portrait display mode.

In this case, the parallax barrier type stereoscopic image display device are illustrated in FIGS. 3 and 4, but the present invention is not limited thereto and can be also applicable to a lens array type stereoscopic image display device.

As illustrated in FIGS. 3 and 4, a case in which pixels are placed horizontally will be referred to as a pixel horizontal direction, and a case in which pixels are placed vertically will be referred to as a pixel vertical direction, for the sake of brevity.

As illustrated, the stereoscopic image display device 110 according to the first exemplary embodiment of the present invention includes a display panel 130 for simultaneously displaying left and right images and a certain parallax barrier 120.

Left eye pixels (L) for displaying a left eye image and right eye pixels (R) for displaying a right eye image are alternately defined on the display panel 130, and the parallax barrier 120 is disposed between the display panel 130 and a user 140.

The left and right eye pixels L and R may be made up of, for example, three sub-pixels 135a, 135b, and 135c of red, green and blue, and slits 122 and barriers 121 for allowing light delivered from the left and right eye pixels L and R to selectively pass therethrough are repeatedly arranged in a strip form in a direction perpendicular to the user 140 on the parallax barrier 120.

Accordingly, a left eye image displayed on the left eye pixel (L) of the display panel 130 reaches the user's left eye through the slits 122 of the parallax barrier 120 and a right eye image displayed on the right eye pixels (R) of the display panel 120 reaches the user's right eye through the slits 122 of the parallax barrier 120. In this case, the left and right eye images include separate images in consideration of the disparity which can be sensed by the human being, and the user combines the two images to recognize a 3D image.

In this case, the width (P) of the left and right eye pixels (L and R) formed on the display panel 130, the width (P1) of the slit 122 of the parallax barrier 120, the width (P2) of the barrier 121 of the parallax barrier 120, and an interocular distance (E) (i.e., the space (E) between the left and right eyes) establish a relational expression 1 shown below:

P1+P2=2/(1/E+1/P) [Relational expression 1]

As mentioned above, the interocular distance (E) is about 65 mm. Thus, the width (P) of the left and right eye pixels (L and R), the width (P1) of the slit 122, and the width (P2) of the barrier 121 may be designed by using the value of the interocular distance (E) and the above relational expression, to implement a 3D stereoscopic image.

The sum of the width (P1) of the slit 122 and the width (P2) of the barrier 121 of the parallax barrier 120 is called a pitch.

In the stereoscopic image display device 110 according to the first exemplary embodiment of the present invention, the barrier pitch is designed to have the same size in the pixel horizontal direction (namely, the landscape display mode) and the pixel vertical direction (namely, the portrait display mode), for pivot driving. Accordingly, 3D image can be viewed at the same viewing distance but a color breaking phenomenon in which colors are mixed to make an image seen abnormal occurs.

With reference to the landscape display mode in FIG. 3, in case of the pixel horizontal direction, red, green and blue colors are mixed and delivered through the barrier 121 to allow for normal viewing of an image. Meanwhile, with reference to the portrait display mode in FIG. 4, in case of the pixel vertical direction, red, green and blue colors are separately shown through the barrier 121, forming a viewing area in which only a particular portion does not have color breaking. Namely, in case of the pixel horizontal direction, light passing through the barrier 121 is in a state in which red, green and blue colors are mixed, while in the case of the pixel vertical direction, because the red, green, and blue colors separately pass through the barrier 121, red, green, and blue colors are not evenly mixed in a certain area, causing color breaking.

Thus, in pivot designing, the color breaking phenomenon generated when a pivot function is implemented can be prevented by designing the barrier pitch appropriate for the landscape display mode and the portrait display mode and adjusting an interocular distance (i.e., the space between the two eyes), and this will be described in detail through a second exemplary embodiment of the present invention.

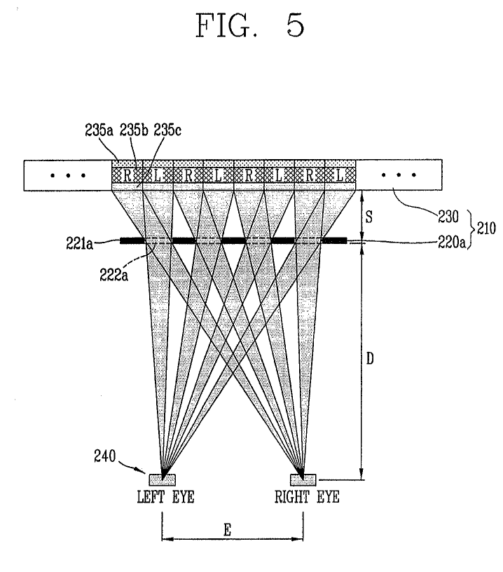

FIG. 5 is a view showing a state of displaying a 3D image in a landscape display mode in the stereoscopic image display device according to a second exemplary embodiment of the present invention, and

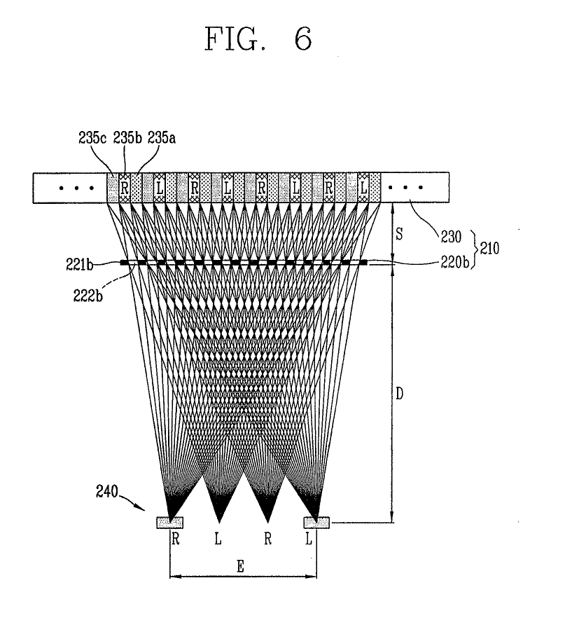

FIG. 6 is a view showing a state of displaying a 3D image in a portrait display mode in the stereoscopic image display device according to the second exemplary embodiment of the present invention.

In this case, FIGS. 5 and 6 show the parallax barrier type stereoscopic image display device, but the present invention is not limited thereto and can be applicable to a lens array type stereoscopic image display device.

As illustrated in FIGS. 5 and 6, a case in which pixels are placed horizontally will be referred to as a pixel horizontal direction, and a case in which pixels are placed vertically will be referred to as a pixel vertical direction, for the sake of brevity.

As illustrated, a stereoscopic image display device 210 according to the second exemplary embodiment of the present invention includes a display panel 230 for simultaneously displaying left and right images and certain parallax barriers 220a and 220b.

Left eye pixels (L) for displaying a left eye image and right eye pixels (R) for displaying a right eye image are alternately defined on the display panel 130, and the parallax barriers 220a and 220b are disposed between the display panel 230 and a user 240.

In this case, the display panel 230 may be configured to be one of a liquid crystal display (LCD), a field emission display (FED), a plasma display panel (PDP), an electroluminescent display (EL).

Also, the left and right eye pixels L and R may have a square shape as well as a rectangular shape, and the present invention is not limited to the shapes of the left and right eye pixels L and R.

In case of the landscape display mode, the left and right eye pixels L and R may include, for example, three sub-pixels 235a, 235b, and 235c of red, green, and blue colors, and in case of the portrait display mode, the left and right eye pixels L and R may include, for example, three sub-pixels 235a, 235b, and 235c of red, green, and blue colors, and the left and right eye pixels L and R are alternately defined in the three sub-pixels 235a, 235b, and 235c arranged in order.

However, the present invention is not limited thereto, and the left and right eye pixels L and R may include four sub-pixels of red, green, blue, and white colors.

The parallax barriers 220a and 220b include a first parallax barrier 220a for the landscape display mode and a second parallax barrier 220b for the portrait display mode, and the barrier pitches are designed to be different according to the landscape display mode and the portrait display mode. In this case, the first slits 222a and the first barriers 221a allowing light emitted from the left and right eye pixels L and R to selectively pass therethrough are repeatedly arranged in a stripe form in a direction perpendicular to the user 240 on the first parallax barrier 220a, and the first slits 222b and the first barriers 221b allowing light emitted from the left and right eye pixels L and R to selectively pass therethrough are repeatedly arranged in a stripe form in a direction perpendicular to the user 240 on the second parallax barrier 220b.

Accordingly, a left eye image displayed on the left eye pixels (L) of the display panel 230 reaches the user's left eye through the first and second slits 222a and 222b of the first and second parallax barriers 220a and 220b, and a right eye image displayed on the right eye pixels (R) of the display panel 230 reaches the user's left eye through the first and second slits 222a and 222b of the first and second parallax barriers 220a and 220b. In this case, the left and right eye images include separate images in consideration of the disparity which can be sensed by the human being, and the user 240 combines the two images to recognize a 3D image.

In this case, in the landscape display mode, horizontal image data is input to the left and right eye pixels L and R, and in the portrait display mode, vertical image data different from the horizontal image data is input to the left and right eye pixels L and R.

Meanwhile, in order to implement a pivot function, a change in the viewing distance (D) must be scarce. Changing of the viewing distance (D) means that the positions of the eyes must be changed according to the landscape display mode or the portrait display mode.

Thus, in order to make the viewing distance (D) the same, the stereoscopic display device according to the first exemplary embodiment of the present invention is designed such that the barrier pitches of the landscape display mode or the portrait display mode are substantially same.

In this case, as described above, color breaking may be generated, so in order to solve this problem, the stereoscopic display device according to the second exemplary embodiment of the present invention is designed such that the barrier pitches of the landscape display mode or the portrait display mode are different. The changing of the barrier pitches means that the pixel pitch related to the barrier is changed. For reference, the barrier pitch is almost double the pixel pitch.

Of course, when the pixel pitch is changed, the viewing distance (D) is changed, but the changed viewing distance (D) can be corrected by changing the interocular distance (E) (i.e., the space between two eyes) considered in designing.

Namely, the viewing distance (D) is determined by the barrier pitch (Pb), the rear distance (S), and the interocular distance (E) as shown in relational expression 2 below:

D=S×E/P, Pb≈2×P [Relational expression 2]

Here, the barrier pitch (Pb) is in inverse proportion to the viewing distance (D). Thus, when the barrier pitch (Pb) is reduced, the viewing distance (D) is increased.

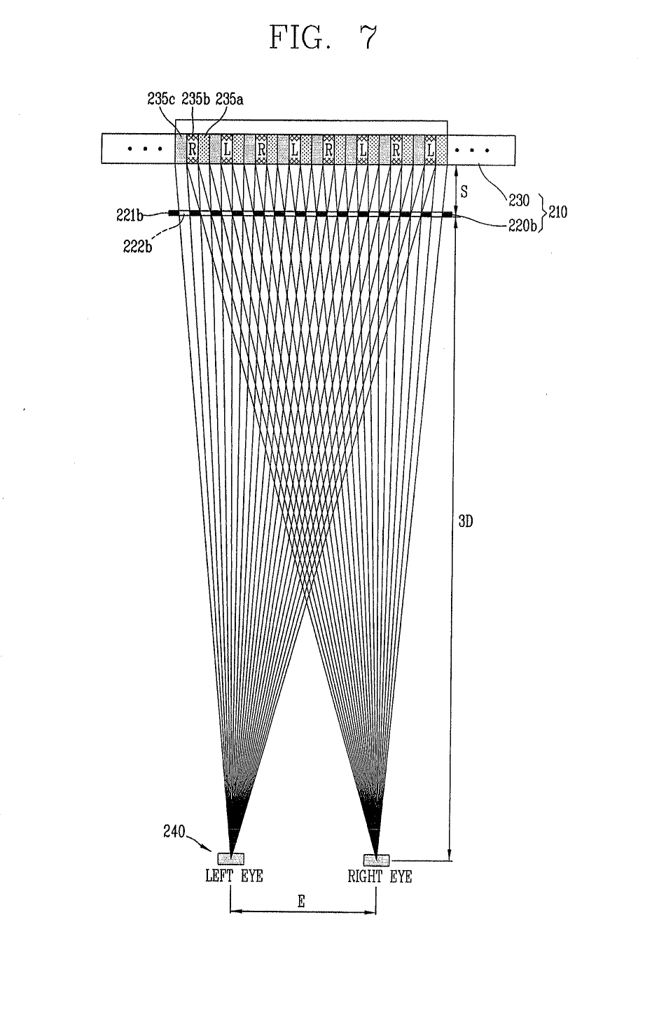

FIG. 7 is a view showing an increase in a viewing distance according to a change in a barrier pitch in the stereoscopic image display device according to the second exemplary embodiment of the present invention.

With reference to FIG. 7, it is noted that when the barrier pitch (Pb) is reduced to be one-third for the pivot function of the portrait display mode, the viewing distance (3D) is increased three times compared with the landscape display mode.

In this case, color breaking is not generated. This is because beams passing through the second slits 222b are made up of sub-pixel units, respective dots corresponding to a left eye image and a right eye image are converged to the precisely same position.

Thereafter, the increased viewing distance 3D must be reduced. Here, the rear distance (S) is physically fixed, so the interocular distance (E) must be corrected.

When the interocular distance (E) is changed, a focused position of an image to the two eyes is changed. However, in case of a glassless 3D using a barrier or a lens, a viewing position is periodically repeated, so based on this, 3D viewing can be possible (See FIG. 6).

In this manner, the stereoscopic image display device according to the second exemplary embodiment of the present invention implements the pivot function in displaying a 3D image, thus meeting various demands of consumers, and can provide an effect of stably displaying a 3D image without causing color breaking according to the viewing direction in case of the pivot driving.

In particular, the stereoscopic image display device according to the second exemplary embodiment of the present invention can be simply designed without affecting the 3D viewing distance or 3D crosstalk in implementing the pivot function, so an additional cost is not incurred.

Meanwhile, the present invention is not limited to the parallax barrier type stereoscopic image display device but can be also applicable to the lens array type stereoscopic image display device, and in this case, the lens pitches are designed to be different for the landscape display mode and the portrait display mode.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A stereoscopic image display device comprising:
a display panel on which left and right eye pixels are alternately defined to display left and right images; and
a first parallax barrier disposed between the display panel and a user and having a first barrier pitch for a landscape display mode and a second parallax barrier disposed between the display panel and the user and having a second barrier pitch for a portrait display mode,
wherein the first and second barrier pitches are different to display a 3D image both in the landscape display mode and in the portrait display mode.

2. The device of claim 1, wherein the display panel is one of a liquid crystal display device, an electroluminescent display, a plasma image display device, and an electric light emitting display device.

3. The device of claim 1, wherein each of the left and right eye pixels has one of a rectangular shape or a square shape.

4. The device of claim 1, wherein the left and right eye pixels comprise three sub-pixels of red, green, and blue, respectively, in the landscape display mode.

5. The device of claim 1, wherein the left and right eye pixels comprise three sub-pixels of red, green, and blue, respectively, in the portrait display mode, and the left and right eye pixels are alternately defined on the three sub-pixels arranged in order.

6. The device of claim 1, wherein the first parallax barrier includes a first slit and a first barrier repeatedly arranged in a stripe form to selectively allow light coming from the left and right eye pixels to pass therethrough.

7. The device of claim 6, wherein the first barrier pitch is the sum of the width of the first slit of the first parallax barrier and the width of the first barrier.

8. The device of claim 1, wherein the second parallax barrier comprises a second slit and a second barrier repeatedly arranged in a stripe form to selectively allow light coming from the left and right eye pixels to pass therethrough.

9. The device of claim 8, wherein the second barrier pitch is the sum of the width of the second slit of the second parallax barrier and the width of the second barrier.

10. The device of claim 1, wherein landscape image data is input to the left and right eye pixels in the landscape display mode, and portrait image data different from the landscape image data is input to the left and right eye pixels.

11. The device of claim 1, wherein the second barrier pitch is one-third of the first barrier pitch in order to display a 3D image in the portrait display mode.

12. The device of claim 11, wherein a viewing distance in the portrait display mode is increased to be triple that in the landscape display mode, the interocular distance is reduced to one-third in order to reduce the increased viewing distance, and a 3D image can be viewed at the same interocular distance of that of the landscape display mode by using a periodically repeated viewing location.
